(19) United States
(12) Patent Application Publication
(10) Pub. No.: US 2012/0069077 A1
(43) Pub. Date: Mar. 22, 2012

(54) MEDIUM HOLDING APPARATUS, INKJET IMAGE FORMING APPARATUS AND INKJET IMAGE FORMING METHOD

(75) Inventors: Yoshiaki Kaneko, Shizuoka-ken (JP); Hirofumi Kondo, Kanagawa-ken (JP); Shigeru Fujiwara, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/232,499

(22) Filed: Sep. 14, 2011

Related U.S. Application Data
(60) Provisional application No. 61/384,053, filed on Sep. 17, 2010.

(51) Int. Cl. B41J 29/38

(52) U.S. Cl. 347/16

(57) ABSTRACT

According to one embodiment, a medium holding apparatus includes an endless device configured to rotate at a predetermined circumferential speed, a charging member arranged to be opposed to the surface of the endless device and configured to apply a voltage to a medium and attract the medium to the endless device using electrostatic force, a charge removing member arranged to be opposed to the surface of the endless device and configured to discharge charges in the medium using an alternating voltage, and a controller configured to offset a reference voltage of the alternating voltage to a polarity opposite to the polarity of the voltage applied during the attraction.

### CROSS-REFERENCE TO RELATED APPLICATION

This application is based upon and claims the benefit of U.S. Provisional Application No. 61/384,053, filed on Sep. 17, 2010; the entire contents of which are incorporated herein by reference.

### FIELD

Embodiments described herein relate generally to a medium holding apparatus, an inkjet image forming apparatus, and an inkjet image forming method.

### BACKGROUND

In the past, there is an image forming apparatus including a mechanism for holding a recording medium such as paper on the surface of a drum, which functions as a holding member, with electrostatic force. As an image forming apparatus such as an inkjet printer, there is an image forming apparatus that forms an image on a recording medium attracted to the surface of a drum. In the image forming apparatus of this type, charges could remain on the surface of the drum. If the polarity of the remaining charges and the polarity of a voltage applied during attraction of the next recording medium are the same, necessary attraction force cannot be obtained.

### BRIEF DESCRIPTION OF THE DRAWINGS

FIG. 1 is a schematic exemplary diagram of a configuration example of an image forming apparatus according to an embodiment;

FIG. 2 is an exemplary diagram of a configuration example of a control system in the image forming apparatus according to the embodiment;

FIG. 3 is an exemplary diagram of a waveform of an alternating voltage for eliminating electrostatic attraction force generated by a charge remover according to the embodiment;

FIG. 4 is exemplary diagram for explaining securing of attraction force by the charge remover according to the embodiment; and

FIG. 5 is an exemplary diagram for explaining an adjusting operation for attraction in the image forming apparatus according to the embodiment.

### DETAILED DESCRIPTION

In general, according to one embodiment, a medium holding apparatus includes: an endless device configured to rotate at a predetermined circumferential speed; a charging member arranged to be opposed to the surface of the endless device and configured to apply a voltage to a medium and attract the medium to the endless device using electrostatic force; a charge removing member arranged to be opposed to the surface of the endless device and configured to discharge charges in the medium using an alternating voltage; and a controller configured to offset a reference voltage of the alternating voltage to a polarity opposite to the polarity of the voltage applied during the attraction.

An image forming apparatus according to an embodiment includes a recording medium holding apparatus that holds a sheet serving as a recording medium. The image forming apparatus according to this embodiment forms an image on the recording medium held by the recording medium holding apparatus. This embodiment can be applied to any image forming apparatus as long as the image forming apparatus includes a mechanism for holding a recording medium. For example, this embodiment can be applied to various printers of an image forming system such as a printer of an inkjet system, a printer of an electrophotographic system, and a printer of a thermal transfer system.

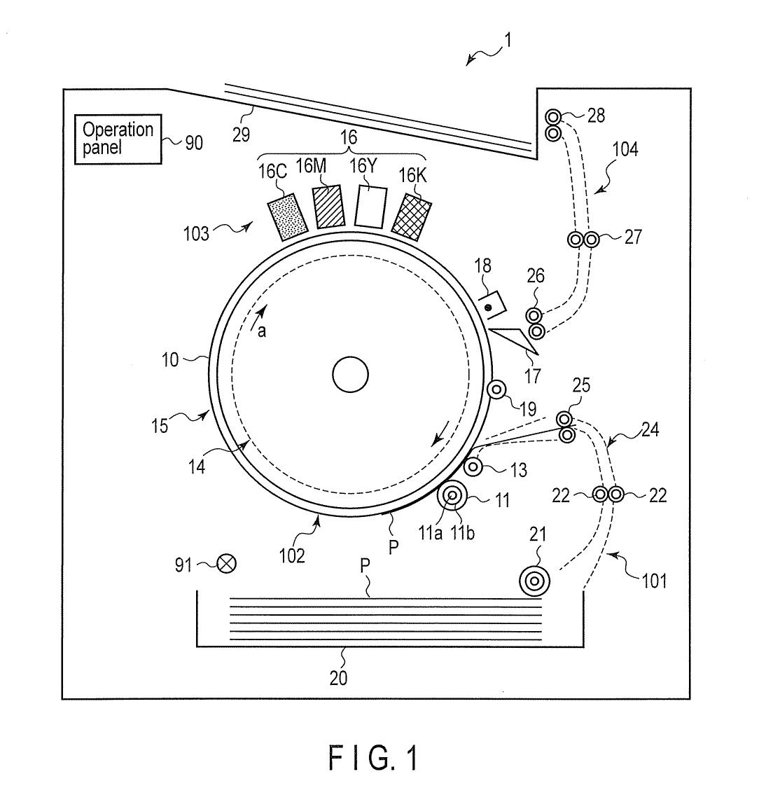

FIG. 1 is a schematic diagram of a configuration example of an image forming apparatus 1 according to an embodiment.

The image forming apparatus 1 shown in FIG. 1 is a printer of an inkjet system (an inkjet printer).

As shown in FIG. 1, the image forming apparatus 1 includes a paper feeding section 101, a sheet holding section 102, an image forming section 103, and a paper discharge section 104. The paper feeding section 101 feeds a sheet serving as a recording medium to the sheet holding section 102. The sheet holding section 102 holds the fed sheet serving as the recording medium in a state in which image formation on the sheet by the image forming section 103 is possible. The image forming section 103 forms an image on the sheet held by the sheet holding section 102. The paper discharge section 104 discharges the sheet having the image formed thereon by the image forming section 103.

The paper feeding section 101 includes a paper feeding cassette 20, a pickup roller 21, a paper feeding roller 22, a sheet conveying path 24, and a registration roller pair 25. The paper feeding cassette 20 stores plural sheets P. The pickup roller 21 picks up the sheets P from the paper feeding cassette 20. The paper feeding roller 22 separates the sheets P, which are picked up by the pickup roller 21, from one another. The paper feeding roller 22 feeds the separated one sheet P to the sheet conveying path 24. The sheet conveying path 24 leads the sheet P, which is conveyed by the paper feeding roller 22, to the registration roller pair 25. The registration roller pair 25 corrects a skew of the sheet P and delivers, at desired timing, the sheet P, the skew of which is corrected, to a drum 10 functioning as a holding member for a recording medium in the sheet holding section 102. The drum 10 may be a belt-like endless device.

The sheet holding section 102 functions as a recording medium holding device as well. The sheet holding section 102 includes a drum 10, a pressing roller 13, a charging roller 11, a charge remover 18, a peeling member (a flapper) 17, and a cleaning member 19. The charging roller 11, the charge remover 18, the peeling member 17, and the cleaning member 19 are arranged in order in positions opposed to the surface of the drum 10 functioning as the holding member for the sheet P.

The drum 10 is the endless device and is the holding member configured to hold the sheet P serving as the recording medium. The drum 10 has a cylindrical shape. The drum 10 rotates in an “a” direction shown in FIG. 1 about the axis of the cylindrical shape. The drum 10 includes a cylindrical frame 14 formed of a conductor and an insulating layer 15 on the surface of the frame 14.

The frame 14 is formed of a conductor of metal such as aluminum. The insulating layer 15 is formed as a thin layer on the surface of the cylindrical frame 14 formed of the conductor. The frame 14 is grounded on the inner side, whereby the potential on the inner side of the frame 14 is set to 0 [V]. The inner side of the frame 14 functions as a counter electrode opposed to the charging roller 11. The potential on the inner side of the frame 14 is maintained as 0 [V]. The drum 10 may be a drum that is flat on a section parallel to a rotating direction of the drum 10.

The charging roller 11 is arranged to be opposed to the outer circumferential surface of the drum 10 and includes a cored bar 11a also serving as the axis of a rotating shaft and a cylindrical conductive member 11b provided on the outer side of the cored bar 11a. A rotating shaft of the drum 10 and the rotating shaft of the charging roller 11 are arranged in parallel. In the charging roller 11, a voltage is applied to the cored bar 11a. The charging roller 11 rotates according to the rotation of the drum 10 in a state in which the cylindrical conductive member 11b is in contact with the surface of the drum 10. The charging roller 11 is pressed against the surface of the drum 10.

The sheet P fed from the registration roller pair 25 rushes into a nip of the pressing roller 13 and unevenness such as creases of the sheet P is smoothed. The sheet P is fed to a nip between the charging roller 11 and the drum 10.

When the sheet P rushes into the nip between the charging roller 11 and the drum 10, for example, a high voltage of +2000 V is applied to the cored bar 11a of the charging roller 11. Since the inner side of the drum 10 is grounded, a potential difference corresponding to potential applied to the charging roller 11 is applied to the nip between the charging roller 11 and the drum 10. In other words, in the nip between the charging roller 11 and the drum 10, the charging roller 11 gives, with the voltage applied to the cored bar 11a, charges to the sheet P adhering to the surface of the drum 10.

The sheet P to which the charges are given by the charging roller 11 is attracted to the surface of the drum 10 by electrostatic force. In other words, the charging roller 11 functions as an attraction-force supplying section (an attracting section) configured to supply attraction force for attracting the sheet P to the drum 10 to the sheet P. The drum 10 rotates with the sheet P attracted to (held on) the surface of the drum 10. The sheet P attracted to the surface of the drum 10 moves to an image forming position by the image forming section 103 according to the rotation of the drum 10.

The image forming section 103 includes a printing head group 16 including plural printing heads 16C, 16M, 16Y, and 16K. The printing heads 16 are set to be opposed to the surface of the drum 10. The printing head 16C ejects cyan ink. The printing head 16M ejects magenta ink. The printing head 16Y ejects yellow ink. The printing head 16K ejects black ink.

The peeling member 17 is arranged near the conveying roller 26 and arranged to be capable of coming into contact with the external circumferential surface of the drum 10. The peeling member 17 has a triangular structure in section.

The charge remover 18 is arranged to be opposed to the outer circumferential surface of the drum 10. The charge remover 18 is opened in a direction opposed to a discharge wire and the drum 10 and is surrounded by a shield in the other directions. The rotating shaft of the drum 10 and the discharge wire of the charge remover 18 are in a parallel relation.

Each of the printing heads 16 ejects ink on the basis of image information to thereby form an image on the front surface of the sheet P attracted to the surface of the drum 10. The drum 10 rotates the number of revolutions corresponding to printing conditions with the sheet P attracted to the surface of the drum 10. The drum 10 can move the sheet P attracted to the surface to the image forming position by the number of times same as the number of revolutions of the drum 10. In other words, the printing head 16 of the image forming section 103 can repeatedly execute image formation on the sheet P by the number of times same as the number of revolutions of the drum 10.

If an image of one color is formed in one revolution of the drum 10, images are formed on a sheet rotating four times together with the drum 10 respectively with inks of four colors (cyan, magenta, yellow, and black) forming full color, whereby a full-color image can be completed. If an image is formed at resolution higher than physical resolution of the printing head 16 itself, images are formed plural times on a sheet rotating plural times together with the drum 10, whereby a high-resolution image can be formed. If an image is formed at high density, images are formed plural times on a sheet rotating plural times together with the drum 10, whereby a high-density image can be formed.

If a sheet attracted to the drum 10 is rotated twice or more to execute image formation plural times, the peeling member 17, the cleaning member 19, and the charging roller 11 may be separated from the surface of the drum 10 by not-shown separating and contacting mechanisms respectively provided in the peeling member 17, the cleaning member 19, and the charging roller 11. Specifically, after the sheet P is attracted to the surface of the drum 10, the peeling member 17, the cleaning member 19, and the charging roller 11 are separated from the surface of the drum 10 until an image is completed. This makes it possible to prevent the peeling member 17, the cleaning member 19, and the charging roller 11 from coming into contact with the front surface of the sheet P on which an image is being formed.

The sheet P having the image formed thereon by the image forming section 103 is peeled off the surface of the drum 10 after being subjected to charge removal and is delivered to the conveying roller 26. When the image formation on the front surface of the sheet P by the image forming section 103 is completed, the charge remover 18 subjects the sheet P to charge removal. The peeling member 17 peels the sheet P off the surface of the drum 10.

The charge remover 18 removes charges from the sheet attracted to the surface of the drum 10. The charge remover 18 removes charges in non-contact with the surface of the drum 10 and the sheet P. For example, the charge remover 18 applies, with a corona discharger, an alternating voltage to the sheet P attracted to the surface of the drum 10. The charge remover 18 applies the alternating voltage to the drum 10 and the sheet P to thereby eliminate electrostatic attraction force applied to the sheet P by the drum 10.

The peeling member 17 peels the sheet P off the surface of the drum 10. The peeling member 17 comes into contact with the surface of the drum 10 before the leading end of the sheet P to be peeled reaches a peeling position. While being in contact with the surface of the drum 10, the peeling member 17 separates the sheet P, on which the image formation is completed, from the surface of the drum 10. The peeling member 17 leads the sheet P peeled off the surface of the drum 10 to the conveying roller 26.

The cleaning member 19 is set between the peeling member 17 and the charging roller 11. The cleaning member 19 cleans the surface of the drum 10. The cleaning member 19 is pressed against the surface of the drum 10 after the peeling of the sheet P. The drum 10 rotates with the cleaning member 19 pressed against the surface of the drum 10, whereby the cleaning member 19 cleans the surface of the drum 10.

The paper discharge section 104 includes plural conveying rollers 26, 27, and 28 and a paper discharge table 29. The sheet P peeled off the surface of the drum 10 by the peeling member 17 is fed to the conveying roller 26. The conveying roller 26 delivers the sheet P to the conveying roller 27. The conveying roller 27 delivers the sheet P, which is fed from the conveying roller 26, to the conveying roller 28. The conveying roller 28 discharges the sheet P, which is fed from the conveying roller 27, to the paper discharge table 29.

In the image forming apparatus 1, an operation panel 90 and a temperature and humidity sensor 91 are provided. The temperature and humidity sensor 91 measures the temperature and the humidity around the image forming apparatus 1.

The configuration of a control system in the image forming apparatus 1 is explained.

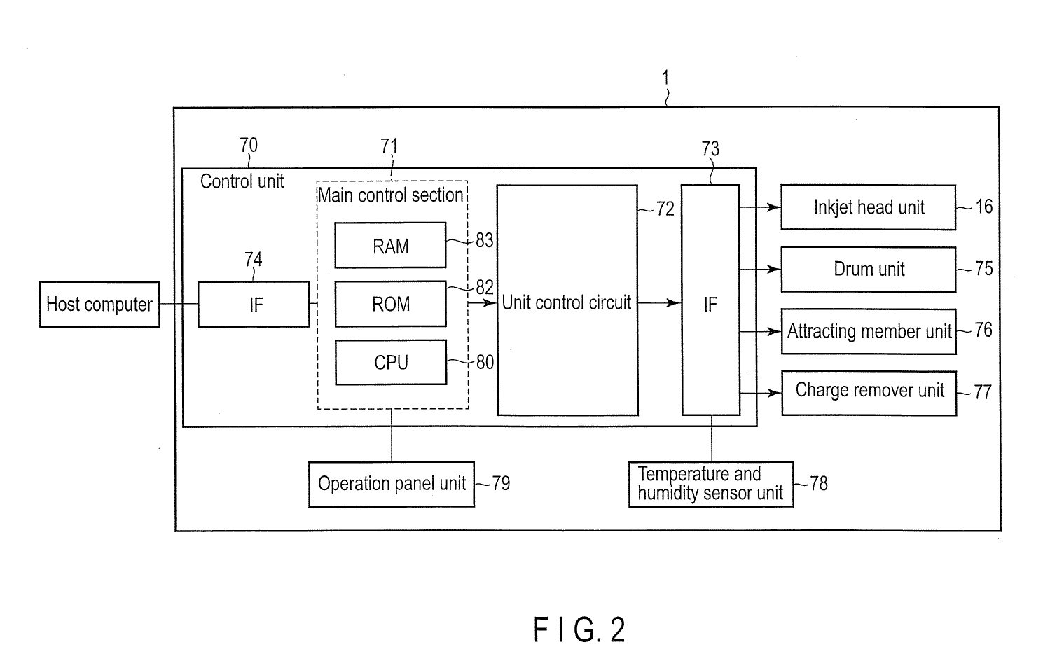

FIG. 2 is a diagram of a configuration example of the control system in the image forming apparatus 1 according to this embodiment.

As shown in FIG. 2, the image forming apparatus 1 includes a control unit 70. The control unit 70 controls the sections of the image forming apparatus 1. The control unit 70 includes a main control section 71, a unit control circuit 72, an internal interface 73, and an external interface 74.

The main control section 71 includes a CPU 81, a ROM 82, and a RAM 83. The CPU 81 is a processor configured to execute control of the sections, data processing, and the like. The ROM 82 has stored therein a control program, control data, and the like. The RAM 83 temporarily stores data. In the main control section 71, the CPU 81 executes, using the RAM 83 functioning as a working memory, the computer program stored in the ROM 82 to thereby realize various kinds of control and data processing.

The unit control circuit 72 is a control circuit for causing the sections to operate according to a control command from the main control section 71. The internal interface 73 is an internal interface for connecting the unit control circuit 72 and the sections in the image forming apparatus 1. The internal interface 73 is connected to the inkjet heads 16, a drum unit 75, an attracting member unit 76, a charge remover unit 77, and a temperature and humidity sensor unit 78. The drum unit 75 includes a motor, a drum motor driving control circuit, and the like not shown in the figure for rotating the drum 10. The attracting member unit 76 includes the charging roller 11 and a charging roller control circuit. The charge remover unit 77 includes the charge remover 18 and a charge remover control circuit. The temperature and humidity sensor unit 78 includes the temperature and humidity sensor 91 and a temperature and humidity sensor control circuit.

The main control section 71 is connected to an operation panel unit 79. The operation panel unit 79 includes the operation panel 90 and an operation panel control circuit. The operation panel 90 is a user interface for a user to input an operation instruction such as printing conditions. For example, the operation panel 90 includes hard keys and a display device incorporating a touch panel. The operation panel 90 includes soft buttons for selection of duplex printing and simplex printing, a type (e.g., size and thickness) of the sheet P, humidity in the apparatus (or around the apparatus), and a state (e.g., a printing ratio, resolution, and a color) of an image formed on a sheet, which are printing conditions.

The main control section 71 is connected to an external apparatus such as a host computer via the external interface 74.

An attraction maintaining operation in the image forming apparatus 1 according to this embodiment is explained below.

As explained above, the recording medium is attracted to and held on the external circumferential surface of the drum 10 by electrostatic force. The charge remover 18 applies the alternating voltage to the drum 10 and the sheet P to thereby eliminate electrostatic attraction force applied to the sheet P by the drum 10.

Since the alternating voltage is applied from the front surface side of the sheet P, in some case, charges escaping to the rear surface side (the drum side) remain without being discharged. If the polarity of the charges remaining on the drum and the polarity of a voltage applied by the charging roller 11 during attraction are the same, an amount of charges injected into the sheet P decreases. Therefore, in some case, attraction force necessary for conveyance cannot be obtained.

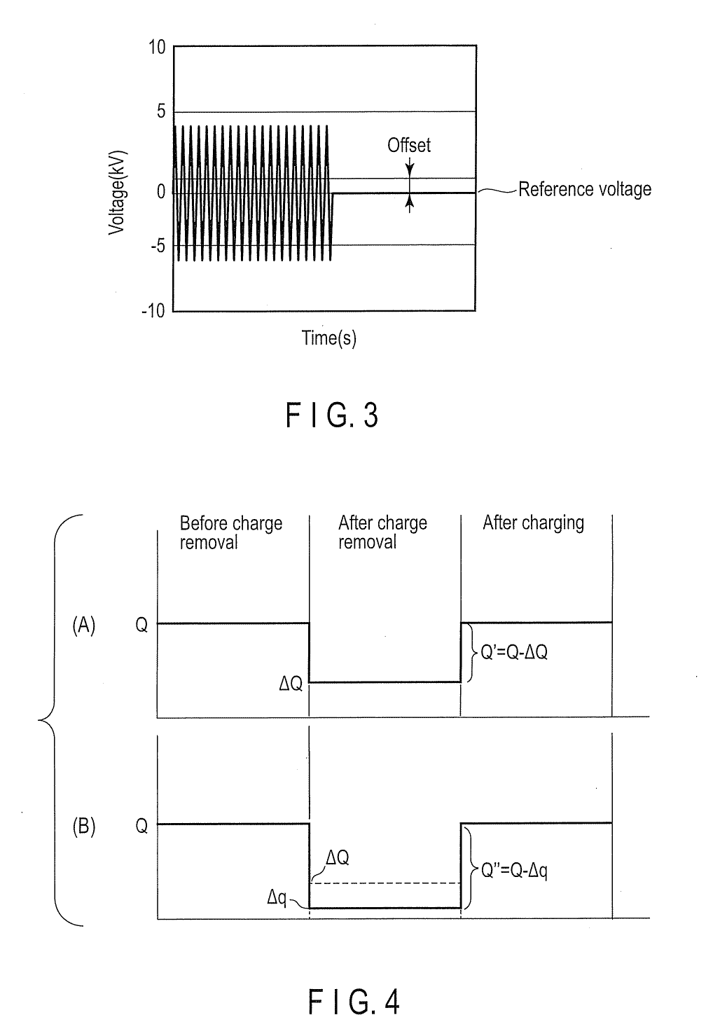

FIG. 3 is a diagram of a waveform of an alternating voltage for eliminating electrostatic attraction force generated by the charge remover 18 according to this embodiment. The alternating voltage is set to, for example, an amplitude of 5 KV and a frequency of 1 KHz. However, a reference voltage value, which is center potential of the alternating voltage, is offset to minus (−) 500 V. In other words, the reference voltage value is adjusted to polarity opposite to the polarity of the voltage applied by the charging roller 11.

The charge remover 18 applies such the alternating voltage to the drum 10, whereby a potential difference between the charging roller 11 and the drum 10 can be increased. Therefore, when the sheet P fed next is charged, it is possible to prevent an amount of charges injected into the sheet P from decreasing. As a result, it is possible to secure attraction force necessary for conveyance of the sheet P.

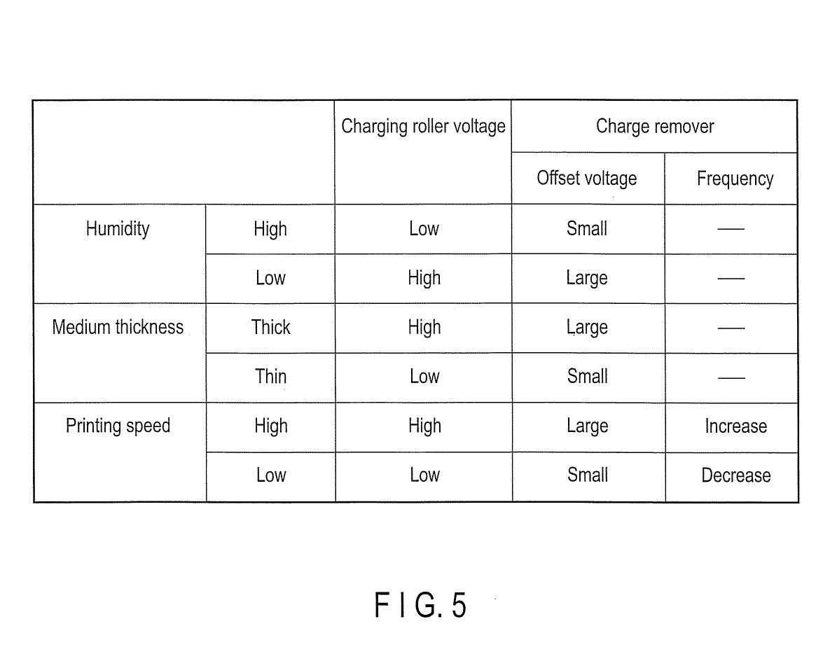

FIG. 4 is diagram for explaining securing of attraction force by the charge remover according to the embodiment.

FIG. 4A is a diagram of a change in a charge amount by a charge removing system in the past. A charge amount Q is injected into the sheet P before charge removal. After the charge removal, a charge amount ΔQ remains on the drum 10. Therefore, if the sheet P is charged by the charging roller 11, a charge amount Q′ smaller by the remaining charge amount ΔQ (=Q−ΔQ) is injected into the sheet P.

FIG. 4B is a diagram of a change in a charge amount by a charge removing system in this embodiment. The charge amount Q is injected into the sheet P before charge removal. After the charge removal, the reference voltage value of the charge remover 18 is adjusted to have polarity opposite to the polarity of the voltage applied by the charging roller 11. As a result, a charge amount Δq remaining on the drum 10 is substantially reduced compared with the remaining charge amount ΔQ in the past. Therefore, if the sheet P is charged by the charging roller 11, a charge amount Q″ smaller by the remaining charge amount Δq (=Q−Δq) is injected into the sheet P. Therefore, it is possible to secure attraction force necessary for conveyance of the sheet P.

In FIG. 4B, in some case, after the charge removal, the drum surface is charged to a polarity opposite to the voltage applied by the charging roller 11. In this case, charges larger than the charge amount Q″ can be injected into the sheet P. Therefore, it is possible to secure attraction force necessary for conveyance of the sheet P.

A charge amount injected into the sheet P, which is the recording medium, fluctuates according to humidity, the thickness of the recording medium, operation conditions for the image forming apparatus 1 such as printing speed, and environmental conditions. Therefore, the main control section 71 adjusts the applied voltage of the charging roller 11 and the alternating voltage of the charge remover 18 according to these conditions.

FIG. 5 is a diagram for explaining an adjusting operation for attraction in the image forming apparatus 1 according to this embodiment.

(1) The main control section 71 adjusts operation conditions for the charging roller 11 and the charge remover 18 according to a humidity value measured by the temperature and humidity sensor 91. Specifically, the main control section 71 adjusts the operation conditions according to a method explained in (1a) and (1b) below.

(1a) If the humidity is higher than a predetermined value α1, since it is easy to inject charges into the recording medium, the main control section 71 reduces the voltage applied by the charging roller 11. Therefore, the main control section 71 reduces an offset amount of the reference voltage of the charge remover 18.

(1b) If the humidity is lower than a predetermined value β1 (<α1), since it is difficult to inject charges into the recording medium, the main control section 71 increases the voltage applied by the charging roller 11. Therefore, the main control section 71 increases the offset amount of the reference voltage of the charge remover 18.

(2) The main control section 71 acquires the thickness (basis weight) of the recording medium according to a type of the recording medium input from the operation panel 90 and adjusts the operation conditions for the charging roller 11 and the charge remover 18 according to the thickness of the recording medium. Specifically, the main control section 71 adjusts the operation conditions according to a method explained in (2a) and (2b) below.

(2a) If the thickness of the recording medium is larger than a predetermined value α2, since it is difficult to inject charges into the recording medium, the main control section 71 increases the voltage applied by the charging roller 11. Therefore, the main control section 71 increases the offset amount of the reference voltage of the charge remover 18.

(2b) If the thickness of the recording medium is smaller than a predetermined value β2 (<α2), since it is easy to inject charges into the recording medium, the main control section 71 reduces the voltage applied by the charging roller 11. Therefore, the main control section 71 reduces the offset amount of the reference voltage of the charge remover 18.

(3) The main control section 71 acquires a printing speed (=a drum circumferential speed) according to an operation mode of the image forming apparatus input from the operation panel 90 and adjusts the operation conditions for the charging roller 11 and the charge remover 18 according to the printing speed. Specifically, the main control section 71 adjusts the operation conditions according to a method explained in (3a) and (3b) below.

(3a) If the printing speed is higher than a predetermined value α3, since it is difficult to inject charges into the recording medium, the main control section 71 increases the voltage applied by the charging roller 11. Therefore, the main control section 71 increases the offset amount of the reference voltage of the charge remover 18. The number of times of alternation applied to the recording medium by the charge remover 18 decreases. Therefore, the main control section 71 increases an alternating frequency.

(3b) If the printing speed is lower than a predetermined value β3 (<α3), since it is easy to inject charges into the recording medium, the main control section 71 reduces the voltage applied to the charging roller 11. Therefore, the main control section 71 reduces the offset amount of the reference voltage of the charge remover 18. The number of times of alternation applied to the recording medium by the charge remover 18 increases. Therefore, the main control section 71 reduces the alternating frequency.

The adjusting operation for attraction in the image forming apparatus 1 is explained above. A limit may be provided in a value to be adjusted. For example, concerning the offset voltage of the reference voltage of the charge remover 18, an adjustment maximum value is ±100 V with respect to 500 V explained above. Concerning the frequency of the charge remover 18, an adjustment maximum value is ±0.5 KHz with respect to 1 KHz explained above.

In the above explanation, although the endless drum 10 is used as the member configured to attract and convey the sheet P, an endless belt may be used. In other words, the sheet P may be attracted to an endless device and conveyed.

In the embodiment, the inkjet image forming apparatus is explained. However, the present invention is not limited to this form and can be understood as a medium holding apparatus that attracts a recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medium holding apparatus comprising:
an endless device configured to rotate at a predetermined circumferential speed;
a charging member arranged to be opposed to a surface of the endless device and configured to apply a voltage to a medium and attract the medium to the endless device using electrostatic force;
a charge removing member arranged to be opposed to the surface of the endless device and configured to discharge charges in the medium using an alternating voltage; and
a controller configured to offset a reference voltage of the alternating voltage to a polarity opposite to polarity of the voltage applied during the attraction.

2. The apparatus according to claim 1, wherein the controller controls an offset amount of the alternating voltage according to humidity in the apparatus.

3. The apparatus according to claim 1, wherein the controller controls an offset amount of the alternating voltage according to thickness of the medium.

4. The apparatus according to claim 1, wherein the controller controls an offset amount of the alternating voltage according to a circumferential speed of the endless device.

5. The apparatus according to claim 1, wherein the controller controls a frequency of the alternating voltage according to a circumferential speed of the endless device.

6. The apparatus according to claim 1, wherein an external circumferential surface of the endless device after peeling of the medium is charged to a polarity opposite to the polarity of the voltage applied during the attraction.

7. An inkjet image forming apparatus comprising:
an endless device configured to rotate at a predetermined circumferential speed;
a charging member arranged to be opposed to a surface of the endless device and configured to apply a voltage to a medium and attract the medium to the endless device using electrostatic force;
an inkjet head configured to eject, on the basis of image information, ink to the medium attracted to the endless device;
a charge removing member arranged to be opposed to the surface of the endless device and configured to discharge charges in the medium using an alternating voltage; and
a controller configured to offset a reference voltage of the alternating voltage to a polarity opposite to polarity of the voltage applied during the attraction.

8. The apparatus according to claim 7, wherein the controller controls an offset amount of the alternating voltage according to humidity in the apparatus.

9. The apparatus according to claim 7, wherein the controller controls an offset amount of the alternating voltage according to thickness of the medium.

10. The apparatus according to claim 7, wherein the controller controls an offset amount of the alternating voltage according to a circumferential speed of the endless device.

11. The apparatus according to claim 7, wherein the controller controls a frequency of the alternating voltage according to a circumferential speed of the endless device.

12. The apparatus according to claim 7, wherein an external circumferential surface of the endless device after peeling of the medium is charged to a polarity opposite to the polarity of the voltage applied during the attraction.

13. An image forming method for an inkjet image forming apparatus, comprising:
rotating an endless device at a predetermined circumferential speed;
applying a voltage to a medium with a charging member and attracting the medium to the endless device using electrostatic force;
ejecting, on the basis of image information, ink to the medium attracted to the endless device;
discharging charges in the medium with a charge removing member using an alternating voltage;
peeling the medium, from which the charges are discharged, with a peeling member; and
offsetting a reference voltage of the alternating voltage to a polarity opposite to polarity of the voltage applied during the attraction.

14. The method according to claim 13, further comprising controlling an offset amount of the alternating voltage according to humidity in the inkjet image forming apparatus.

15. The method according to claim 13, further comprising controlling an offset amount of the alternating voltage according to thickness of the medium.

16. The method according to claim 13, further comprising controlling an offset amount of the alternating voltage according to a circumferential speed of the endless device.

17. The method according to claim 13, further comprising controlling a frequency of the alternating voltage according to a circumferential speed of the endless device.

18. The method according to claim 13, wherein an external circumferential surface of the endless device after peeling of the medium is charged to a polarity opposite to the polarity of the voltage applied during the attraction.
